(19) United States
(12) Patent Application Publication
(10) Pub. No.: US 2014/0121857 A1
(43) Pub. Date: May 1, 2014

(54) SYSTEM FOR CHARACTERIZING THE DRIVING STYLE OF VEHICLE DRIVERS

(71) Applicant: INFOMOBILITY.IT S.P.A, Teramo (IT)

(72) Inventor: Franco Iachini, Teramo (IT)

(73) Assignee: INFOMOBILITY.IT S.P.A, Teramo (IT)

(21) Appl. No.: 14/146,980

(22) Filed: Jan. 3, 2014

Related U.S. Application Data
(63) Continuation-in-part of application No. 13/548,716, filed on Jul. 13, 2012.

(30) Foreign Application Priority Data
Feb. 9, 2012 (EP) 12154654.3

(51) Int. Cl. G06Q 40/08

(52) U.S. Cl. CPC G06Q 40/08
USPC 701/1

(57) ABSTRACT

A system and method of characterizing the driving style of a vehicle driver, comprising determining, by a processor, a vehicle path of a driver, determining one or more average speed values of the vehicle driver from at least the vehicle path, determining a number of times an average vehicle speed in one or more road sections is exceeded by one or more average speed values of the driver and characterizing the driving style of the vehicle driver from at least the one or more average speed values of the driver. Determining a vehicle path of a driver comprises loading one or more GPS points or generic paths, performing a range search for each GPS point, determining one or more unique GPS snap points for each GPS point, determining one or more estimated vehicle paths for each unique GPS snap point and determining a vehicle path from the estimated vehicle paths.

### PRIORITY CLAIM

The present application is a continuation-in-part and claims the priority of U.S. patent application Ser. No. 13/548,716, filed on Jul. 13, 2012, which claims the benefit of European Patent Application No. 12154654.3, filed Feb. 9, 2012, the entire contents of which are incorporated herein by reference.

### BACKGROUND

The present patent application for industrial invention relates to an assessment system of a risk indicator associated with the driving style of a vehicle driver.

The present patent application for industrial invention relates to an assessment system of a risk indicator associated with the driving style of a vehicle driver.

Satellite navigators for vehicles are largely known on the market, which operate with GPS protocol to indicate the exact position of a vehicle on the territory.

Satellite localization devices are largely known on the market, which are also used as antitheft device to signal the position of a stolen vehicle.

Accident detectors (crash sensors) for vehicles are also known, generally in the form of accelerometers that detect a sudden acceleration variation of the vehicle indicative of a crash. Said crash sensors are generally connected to the vehicle airbags.

Mobile telephones integrated in the vehicle are also known, which operate with GSM or GPRS protocol to make telephone calls from the vehicle.

US2005/037730, WO2009/133450, GB2390208, US202/037707 disclose device mounted onboard a vehicle to signal an accident to a competent office, such as breakdown service, police and the like.

However, none of the aforementioned prior documents discloses the use of said devices to assess a risk indicator of the vehicle driver.

Generally, insurance policies are drawn up by insurance companies based on the accident risk of the vehicle driver. Therefore, it would be desirable for insurance companies to have a system able to assess the accident risk of the vehicle driver objectively.

### SUMMARY

The purpose of the present invention is to provide an assessment system of the risk indicator of the vehicle driver that is reliable and simple to make and use.

These purposes are achieved according to the invention, with characteristics claimed in independent claim 1.

Advantageous embodiments appear from the dependent claims.

According to the invention the assessment system of a risk indicator of the vehicle driver uses an accelerometer to detect the acceleration and deceleration values of a vehicle, a GPS to detect the position and speed of a vehicle and a GSM/GPRS module to send the detected data to an operations center that calculates the assessment of the risk indicator of the vehicle driver.

### BRIEF DESCRIPTION OF THE DRAWINGS

Further characteristics of the invention will appear more evident from the following description, which refers to a merely illustrative, not limiting embodiment, illustrated in the attached drawings, wherein:

FIG. 1 is an exploded perspective view of a box used to contain the device for implementation of the process according to the invention;

FIG. 2 is a block diagram showing the functional blocks and the operation of the device for implementation of the process according to the invention;

FIG. 3 is a block diagram showing the process of the invention;

FIG. 4 is a block diagram showing the process implemented by the operations center;

FIG. 5 is a block diagram of an operations center in accordance with one or more embodiments;

FIG. 6 is a flow chart of a method of determining a vehicle path in accordance with one or more embodiments;

FIG. 7 is a flow chart of a method of determining one or more unique GPS snap points for each GPS point in accordance with one or more embodiments;

FIG. 8 is a flow chart of a method of associating GPS points with one or more GPS snap points in accordance with one or more embodiments;

FIG. 9 is a flow chart of a method of determining one or more estimated vehicle paths for each unique GPS snap point in accordance with one or more embodiments; and

FIG. 10 is a block diagram of a map match system for determining a vehicle path in accordance with one or more embodiments.

### DETAILED DESCRIPTION

The following disclosure provides many different embodiments, or examples, for implementing different features of the disclosed subject matter. Specific examples of components and arrangements are described below to simplify the present disclosure. These are examples and are not intended to be limiting.

This description of the embodiments is intended to be read in connection with the accompanying drawings, which are to be considered part of the entire written description. In the description, relative terms such as “before,” “after,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the system be constructed or operated in a particular orientation. Terms concerning attachments, coupling and the like, such as “connected” and “interconnected,” refer to a relationship wherein components are attached to one another either directly or indirectly through intervening components, unless expressly described otherwise.

Referring to the aforementioned figures, the device for implementation of the process according to the invention is disclosed, being generally indicated with numeral (1).

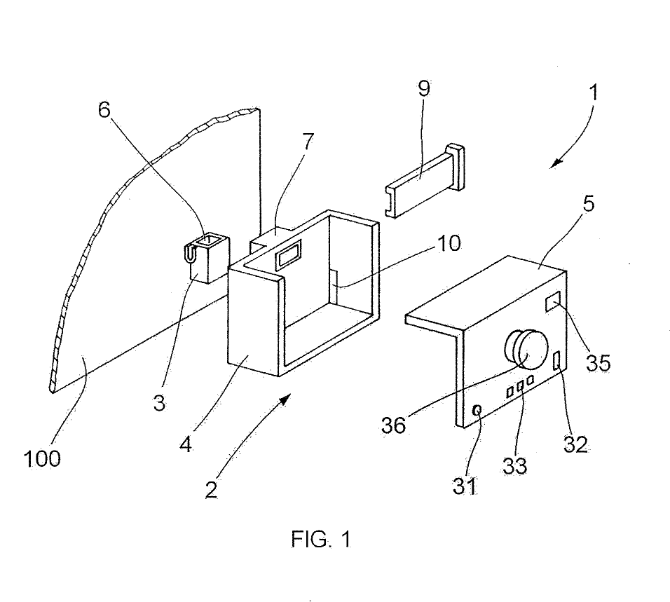

Referring to FIG. 1, the device (1) comprises a container box (2) and a support connector (3).

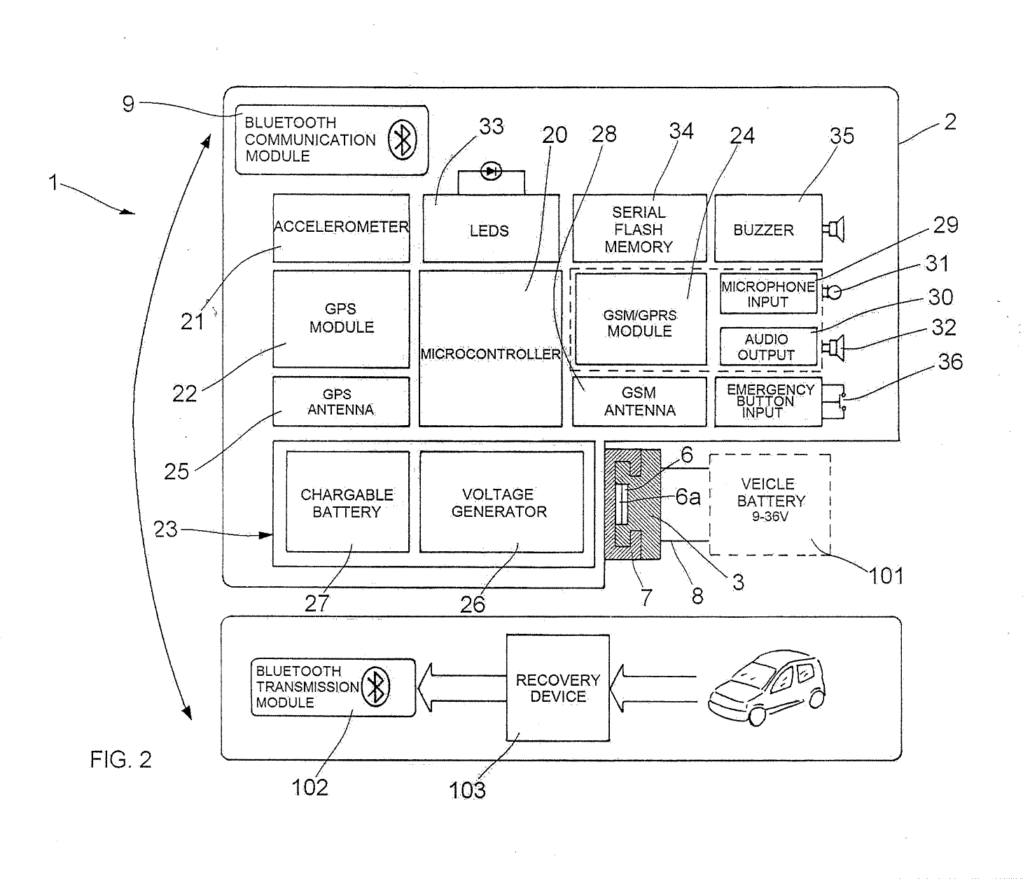

The container box (2) comprises a base (4) and a lid (5) and is adapted to contain all functional blocks shown in FIG. 2, as illustrated below.

Going back to FIG. 1, the support connector (3) is fixed to a windshield (100) of the vehicle with permanent tape. As shown in FIG. 2, electrical contacts (6) are provided in the support connector (3) to go in contact with electrical contacts (6a) of a complementary connector (7) provided on the base of the container box.

Referring to FIG. 2, the support connector (3) is connected to a battery (101) of the vehicle by means of electrical cables.

Going back to FIG. 1, the device (1) can be optionally provided with a Bluetooth communication module (9) that can be inserted into a dedicated slot (10) of the base of the box (2).

Referring to FIG. 2, the Bluetooth communication module (9) communicates with a Bluetooth transmission module (102) connected to a retrieval device (103) adapted to retrieve information on vehicle from the vehicle control unit.

The box (2) contains a microcontroller (20), an accelerometer (21), a GPS satellite module (22), a power supply unit (23) and a GSM/GPRS mobile telephone module (24).

The microcontroller (20) controls the operation of all the devices of the device (1).

The accelerometer (21) is preferably of 3-axis type, adapted to detect sudden accelerations or deceleration of the vehicle indicative of improper driving or accident.

The GPS satellite module (22) is provide with integrated GPS antenna (25) in order to detect the exact position of the vehicle.

The power supply unit (23) comprises a voltage generator (26) that takes 9-36V power from the battery (101) of the vehicle and converts it to suitably power all the devices contained in the box of the device. The power supply unit (23) also comprises a backup rechargeable battery (27) contained in the box (2).

The GSM/GPRS mobile telephone module (24) comprises a GSM integrated antenna (28) for connection with a mobile telephone network. The GSM/GPRS mobile telephone module (24) also comprises one audio input (29) and one audio output (30) of hands-free type. Referring to FIG. 1, the audio input (29) and the audio output (30) are respectively connected to a microphone (31) and a loudspeaker (32) installed on the walls of the lid (5) of the box. The GSM/GPRS mobile telephone module (24) is adapted to connect with an assistance center in such manner to send messages and/or put the vehicle driver in communication with the assistance center.

The installation of the device (1) on the windshield (100) of the vehicle allows for positioning the microphone (31) and loudspeaker (32) in the best position for the driver's use.

The device (1) comprises a data storage memory (34). The memory (34) can be of NAND flash serial type.

Optionally, the device (1) can comprise a LED unit (33), an audio buzzer (35) and an emergency button (36).

The LED unit (33), the audio buzzer (35) and the emergency button (36) are installed on a wall of the lid (5) of the box in order to be accessible for the user. The emergency button (36) is connected to the mobile telephone module (24) to put the driver in communication with the assistance center.

Going back to FIG. 1, it must be considered that the support connector (3), the base (4) and the lid (5) of the box are mutually closed with key or anti-tampering screw. Moreover, the microcontroller (20) constantly monitors the electrical contacts (6, 6a) of the connector (3) and of the box (2) in order to detect a possible attempt of disconnection of the box from the connector or tampering.

The operation of the device (1) is disclosed hereinafter.

The GPS module (22) constantly detects the exact position of the vehicle. When the vehicle has an accident, the accelerometer (21) detects the accident and sends the signal to the microcontroller (20). The microcontroller (20) activates the GSM/GPRS module (24) that sends an accident signal to the assistance center, together with the exact position of the vehicle detected by the GPS module (22). So, the assistance center can provide rapid assistance to the vehicle. Moreover, by means of the GSM/GPRS module (24), the driver is put into communication with the assistance center.

The device (1) of the invention permits the following functions:
Localize the vehicle, in case of theft, by means of the GPS module (22).
Collect data to record the use of the vehicle (traveled kilometers by road type and use time) and collect data to evaluate the “driving behavior” of the driver by means of the Bluetooth communication module (9).
Send the aforementioned information to a remote station by means of the GSM/GPRS module (24).
Detect a removal and/or tampering attempt by means of the microcontroller (20) connected to the electrical contacts.
Generate an alarm in case of removal and/or tampering by means of the buzzer (35) and send the alarm signal to a remote station by means of the GSM/GPRS module (24).
Activate an emergency call by means of the emergency button (36) and the GSM/GPRS module (24).
Detect a crash (crash definition: impact with acceleration higher than 2.5 g) by means of the accelerometer (21)
Generate an alarm in case of crash by means of the buzzer (35); send crash information to a remote station by means of the GSM/GPRS module (24) and, in case of crash, establish a hands-free call from external support operators by means of the emergency button (36) and the GSM/GPRS module (24).

The software installed in the device (1) offers a series of safety and fleet management functionalities that can be used by means of an operations center.
Vehicle localization and tracking on demand. The peripheral unit can be interrogated over the GSM/GPRS channels to update the GPS position and the status of the on board apparatus.
Crash detection. The on board system detects the crash event by means of the accelerometer (21).
Automatic emergency call. The system makes an automatic call to the operations center. Information includes date, georeferencing, and vehicle type.
Manual emergency call. The system is provided with an emergency button (36) for the user to make an emergency call.
Rescue sending. After making the necessary checks, according to the type of accident, the operations center sends the rescue means (ambulance, fire brigade, breakdown truck).
Other alarm events. The peripheral unit controls other types of alarm, such as:
Theft (movement and/or lifting of vehicle)
Tampering.
Battery removal. Also in this case an emergency call is made to the operations center, including information on the vehicle position.
Reports and travel history. The individual travels made by the vehicle are recorded (switch-on and switch-off). The position is sampled every 2 seconds and the history of the positions is sent with frequency configurable at least every 7 minutes. Each sample includes latitude, longitude, speed and date. By means of proprietary coding system, the traffic generated for transmission of said data does not exceed 300 Kb a month, assuming an average use of the vehicle of about 2 hours a day.

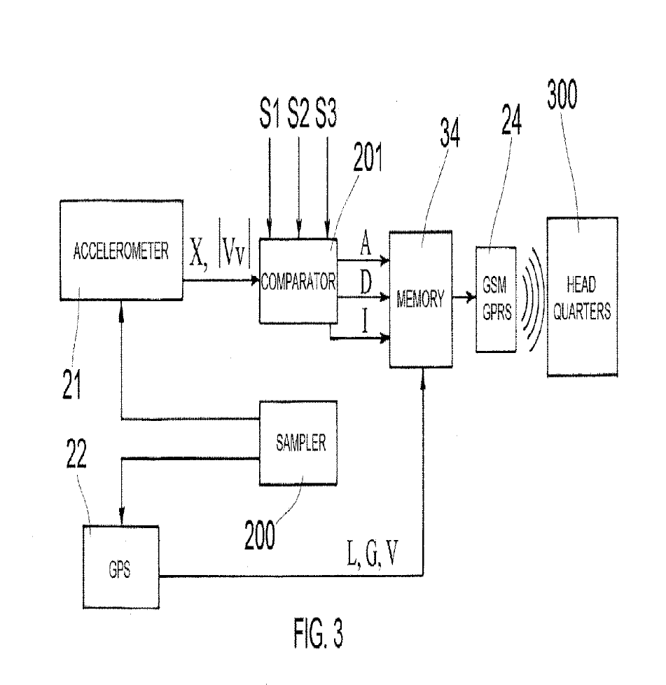

Referring to FIG. 3, the microprocessor (20) comprises a sampler (200) and a comparator (201). The sampler (200) samples the accelerometer (21) at a frequency from 800 to 1200 Hz. The samples of accelerations (A) detected by the accelerometer (21) are processed by the microprocessor (20) that is responsible for identifying sudden accelerations/decelerations made by the driver and indicative of improper driving and very sudden accelerations and decelerations made by the vehicle and indicative of a crash.

During the installation of the device (1) a rotation matrix is automatically determined to pass from the reference system of the accelerometer (21) to the reference system of the vehicle. The rotation matrix is necessary to project the acceleration measures from the reference system of the accelerometer (Xₐ Yₐ Zₐ) to the reference system of the vehicle (X Y Z), assuming that in the reference system of the vehicle axis X corresponds to the traveling direction and axis Y is orthogonal and coplanar to axis X. The accelerometer (21) detects an acceleration vector vₐ(x,y,z) on three axes in the XₐYₐZₐ reference system. The vector vₐ is projected in the XYZ reference system of the vehicle obtaining a vector vᵥ(x,y,z). The component X of the vector vᵥ represents the instantaneous acceleration recorded along the traveling direction of the vehicle and is useful for the evaluation of sudden accelerations and braking. Acceleration is detected if the component X of the vector vᵥ is positive, whereas deceleration is detected if the component (X) of vᵥ is negative. In order to identify a crash, the system takes into consideration the module of the vector vᵥ. The two elements, i.e. component x of vᵥ and module of vᵥ, are sent to the comparator (201). The component X is compared with threshold values S1, S2 and the module of vᵥ is compared with threshold value S3. The first threshold value (S1) indicates a sudden acceleration and is set at approximately ½ g. The second threshold value (S2) indicates a sudden deceleration and is set at approximately −½ g. The third threshold value (S3) indicates a very sudden acceleration/deceleration indicative of a possible crash and is set at approximately 2 g.

If the component X of vᵥ is higher than the first threshold value (S1), the comparator (201) sends a signal (A) indicative of the sudden acceleration to the memory (34). If the component X of vᵥ is lower than the second threshold value (S2), the comparator (201) sends a signal (D) indicative of the sudden deceleration to the memory (34). If the module of the vector vᵥ is higher than the third threshold value (S3), the comparator (201) sends a signal (I) indicative of a crash to the memory (34).

If the comparator (201) detects that the module of the vector vᵥ exceeds the third threshold value (S3), the microcontroller (20) records the entire dataset of sampled accelerations in the memory (34) in a range comprised between 10 seconds before and 3 seconds after the instant in which the threshold is exceeded. Then, the microcontroller (20) locally records the event in the memory (34), identifying it as a crash event (I).

The sudden acceleration values (A), sudden deceleration values (B) and crash events (I) are sent to an operations center (300) by means of the GSM/GPRS module (24).

The microprocessor (20) samples the GPS (22) at a frequency of approximately 1-10 Hz. The GPS (22) detects three values: latitude (L), longitude (G) and speed (V) of the vehicle. The samples of latitude (L), longitude (G) and speed (V) acquired by the GPS (22) are recorded in the memory (34) in order to be successively sent to the remote operations center (300) by means of the GSM/GPRS module (24).

If the GPS signal is not available, the speed of the vehicle (V) is detected by the information retrieval device (103) of the control unit of the vehicle and sent to the memory (34) of the device by means of the Bluetooth modules (102, 9).

At programmable intervals or upon request from the remote operations center (300), the device (1) sends the acquired data to the operations center (300) by means of the GSM/GPRS module (24). The remote operations center (300) receives the data from the device (1) and records it in a database in order to make it available for calculation of the risk indicator associated with the driving style of the vehicle driver. The calculation of the risk indicator is made at regular intervals, when the operations center (300) has collected a relevant quantity of data. In some embodiments, the database is stored in storage medium 1004.

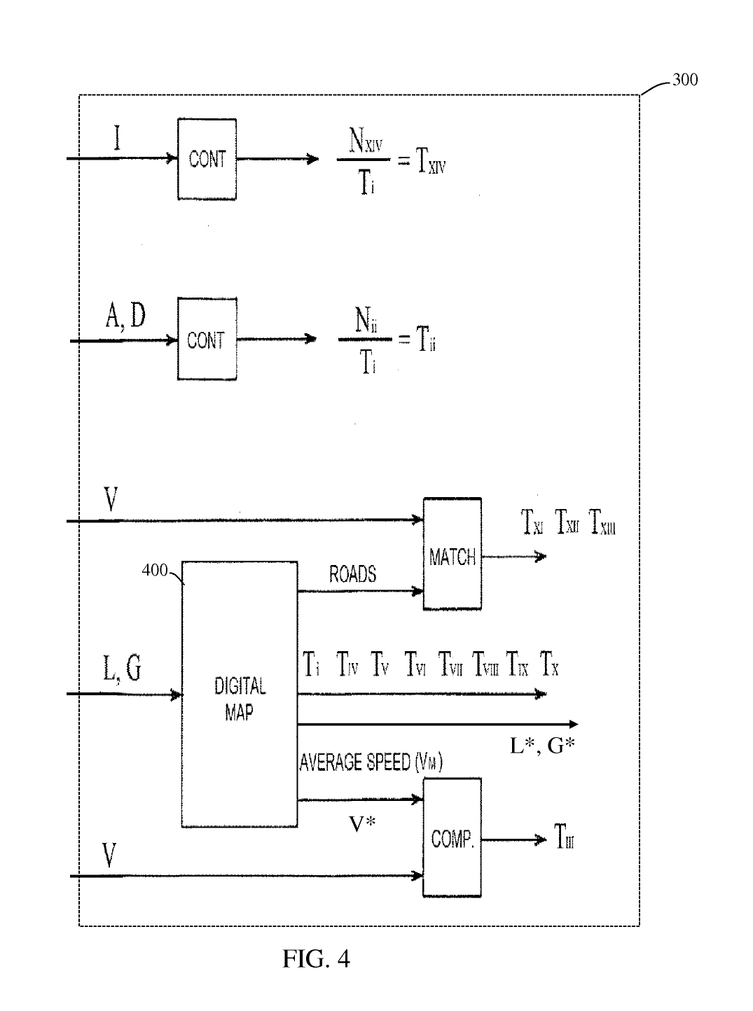

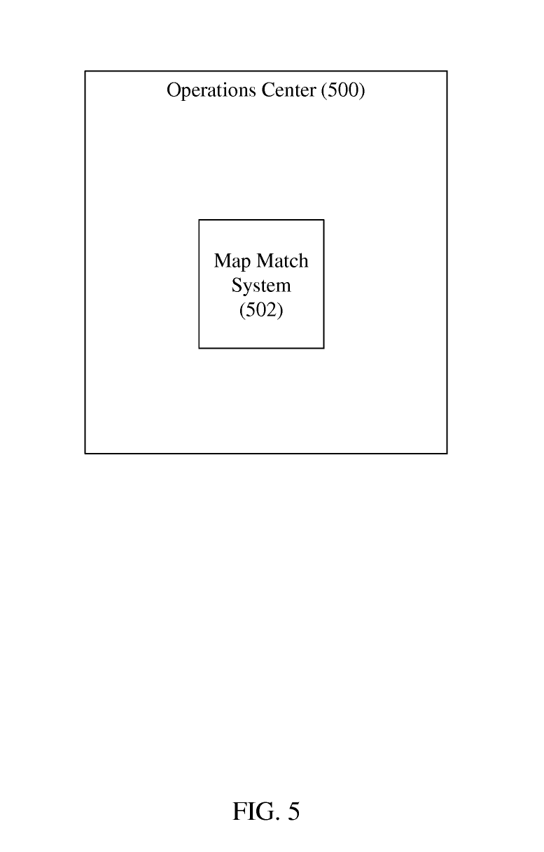

FIG. 4 is a block diagram of a process implemented by the operations center 300. Referring to FIG. 4, the operations center 300 receives the first latitude (L), first longitude (G) and the speed of the vehicle (V) detected by the GPS (22). In some embodiments, each data point of the first latitude (L) and first longitude (G) detected by the GPS (22) are projected on digital mapping 400 through a mapmatch algorithm. In some embodiments, each data point of the first latitude (L) and the first longitude (G) is associated with a corresponding GPS node. In some embodiments, a GPS node is the coordinates corresponding to the first latitude (L) and the first longitude (G). In some embodiments, the error introduced by the GPS (22) is reduced by projecting each data point of the first latitude (L) and first longitude (G) by digital map 400 and reconstructing the path of the vehicle such that the reconstructed vehicle path follows one or more road maps extracted from an external road network. In some embodiments, each data point of the first latitude (L) is translated to a corresponding second latitude (L*). In some embodiments, each data point of the first longitude (G) is translated to a corresponding second longitude (G*). In some embodiments, each of the corresponding second latitude (L*) and the corresponding second longitude (G*) are associated with a corresponding unique GPS snap point. In some embodiments, a unique GPS snap point is the coordinates corresponding to the second latitude (L*) and the second longitude (G*). In some embodiments, each of the GPS nodes is translated to a corresponding member of one or more unique GPS snap points. In some embodiments, the error introduced by the GPS (22) is reduced by translating one or more GPS nodes to one or more unique GPS snap points on the digital map 400 through a second map match algorithm (e.g., shown as method 500 in FIG. 5).

In some embodiments, the GPS data projected on the mapping (e.g., first latitude (L), first longitude (G) second latitude (L*) or second longitude (G*), the speed of the vehicle (V) detected by the GPS or by the control unit of the vehicle, the speed of the vehicle (V*) determined by the Digital Map 400, the sudden accelerations and decelerations (A, D) and the crash events (I) detected by the accelerometer are used to obtain parameters indicative of the driving style of the vehicle driver.

In some embodiments, accelerations (A) and decelerations (D) are counted in such manner to obtain a number (Nii), and also accidents (I) are counted in such manner to obtain a number of accidents (Nxiv).

In some embodiments, the following information is obtained from the latitude (L) and longitude (G) detected by the GPS (22) and projected on the mapping, following the path of the vehicle on the mapping: total kilometers traveled by the vehicle and kilometers traveled by the vehicle in different types of road, such as highways, suburban roads, urban roads, one-way streets, two-way streets. Also information about the transits of the vehicle is obtained, that is the number of times the vehicle passes through a junction or around a roundabout.

In some embodiments, the first latitude (L), first longitude (G) and speed (V) detected by the multiple devices (1) installed in circulating vehicles and the second latitude (L*) or second longitude (G*) or the speed of the vehicle (V*) are used by the system of the operations center (300) to calculate, for each section of road of the digital mapping, an average speed (V_{M}), i.e. the speed maintained by the majority of users in the specific section of road. In some embodiments, the speed of the vehicle (V*) is determined between each unique GPS snap point from at least the second latitude (L*) and the second longitude (G*). For example, the speed of the vehicle (V*) is determined by formula 1:

$${V}^{*} = \frac{{S}_{current} - {S}_{previous}}{{T}_{current} - {T}_{previous }} \qquad ( 1 )$$

Where V* is the speed of the vehicle between a current unique GPS snap point and a previous unique GPS snap point, S_{current} is the current unique GPS snap point, Sₚᵣₑᵥᵢₒᵤₛ is the previous unique GPS snap point, T_{current} is the time for the current unique GPS snap point and Tₚᵣₑᵥᵢₒᵤₛ is the time for the previous unique GPS snap point. In some embodiments, V* is the average speed of the vehicle between a current unique GPS snap point and a previous unique GPS snap point. In some embodiments, the average speed of the vehicle (V*) is determined from at least the vehicle path.

Successively, by comparing the speed values (V) detected by the GPS (22) or by the information retrieval device (103) with the average speed (V_{M}) on the section of road where the vehicle is traveling or the speed of the vehicle (V*), information on the number of times the speed is exceeded by the individual driver (speed deviation of the individual user from the average behavior) is obtained. In some embodiments, a number of times an average vehicle speed in one or more road sections (V_{M}) is exceeded by one or more average speed values of the vehicle driver (V*) are determined. In some embodiments, a number of times an average vehicle speed in one or more road sections (V_{M}) is exceeded by one or more average speed values (V) detected by the GPS (22) is determined. In some embodiments, the driving style of the vehicle driver is characterized from at least the one or more average speed values (V*) of the vehicle driver. In some embodiments, the driving style of the vehicle driver is characterized from at least the one or more speed values (V) detected by the GPS (22).

Moreover, by matching the speed values (V) detected by the GPS (22), the speed values (V*) or by the information retrieval device (103) with the roads traveled by the vehicle detected from the mapping, information is obtained on the average speed in various types of road, such as highways, suburban roads, urban roads.

The following parameters are calculated by the software program of the operations center (300):

i. Total number of kilometers traveled

ii. Number of sudden accelerations (A) and/or decelerations (D)/total kilometers

iii. Number of times in which speed is exceeded

iv. Kilometers traveled on highways/total kilometers

v. Kilometers traveled on suburban roads/total kilometers

vi. Kilometers traveled on urban roads/total kilometers

vii. Number of transits in junction/traveled kilometers

viii. Number of transits in roundabout/traveled kilometers

ix. Kilometers traveled on one-way roads/total kilometers

x. Kilometers traveled on two-way roads/total kilometers

xi. Average speed on highway

xii. Average speed on suburban roads

xiii. Average speed on urban roads

xiv. Number of accidents (I)

These parameters (Tᵢ . . . Tₓᵢᵥ) represent the terms of a polynomial of type P=K₁Tᵢ+K₂Tᵢᵢ+ . . . K₁₄Tₓᵢᵥ. The result of the polynomial is a value that is representative of the driving style of the driver.

Coefficients (K1 . . . K14) are determined according to an analysis to be carried out on a significant sample of test users, with known behavior set in advance. For instance, a calibration campaign of the model can be planned, with n typologies of different users traveling for one week: the first subset of users following a very caution driving behavior, the second subset following a normal behavior and the third subset following a risk behavior.

Consequently, it will be possible to collect three subsets of homogeneous data and then calculate the representative value of the driving style (P) for three different risk classes (cautious, normal, risky). Therefore, the determination of the coefficients K is such that these coefficients interpolate in linear or polynomial manner the intermediate behaviors of the users and the polynomial provides a number comprised between 0 and 10 representative of the user's risk P=0 (low risk); P=10 (high risk).

FIG. 5 is a block diagram of an operations center 500 in accordance with one or more embodiments. In some embodiments, the operations center 500 is an embodiment of the remote operations center 300 shown in FIGS. 3 and 4. Operations center 500 includes a map match system 502. In some embodiments, map match system 502 determines the vehicle path of a vehicle by implementing method 600, 700, 800 or 900. In some embodiments, map match system 500 is an embodiment of the Digital Map 400 shown in FIG. 4.

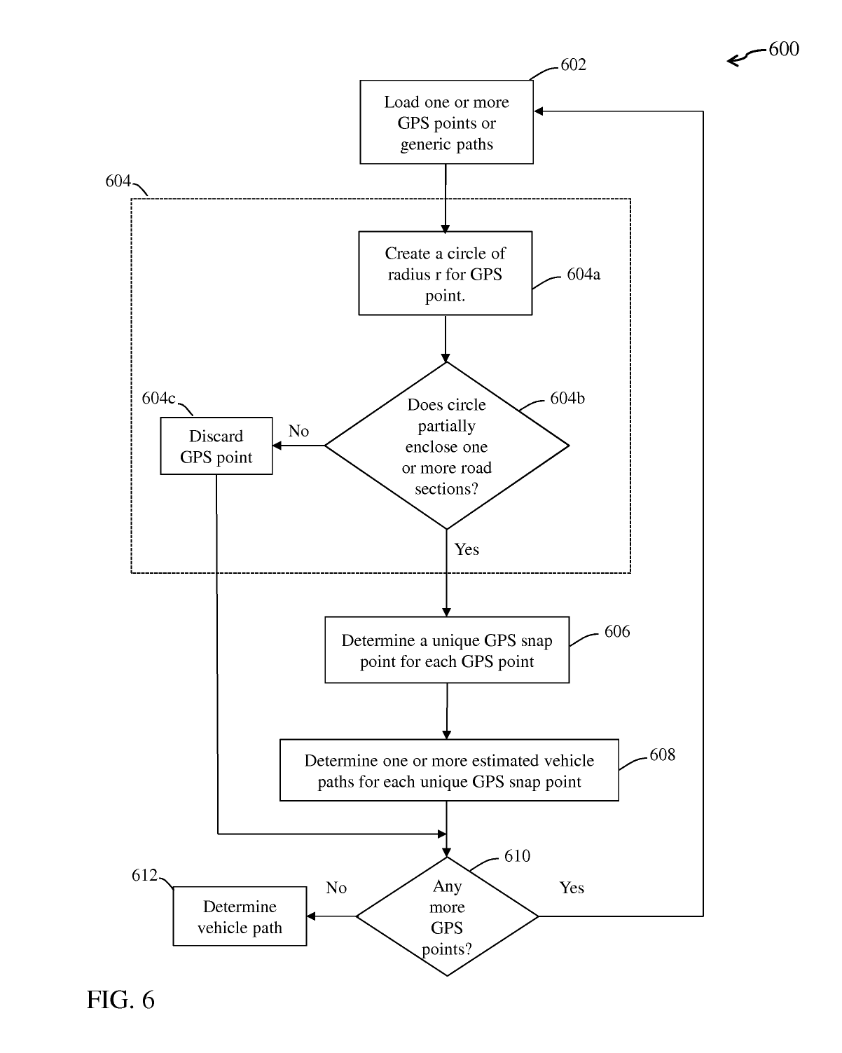

FIG. 6 is a flow chart of a method 600 of determining a vehicle path in accordance with one or more embodiments. In some embodiments, method 600 is implemented by map match system 502. Method 600 begins with operation 602 in which one or more GPS points or one or more generic paths are loaded into a map match system 502. In some embodiments, the GPS points are received by the operations center 500. In some embodiments, a generic path is a connection of one or more road sections. In some embodiments, a generic path comprises one or more estimated vehicle paths. In some embodiments, a road section is a portion of a road. In some embodiments, the road section corresponds to a portion of a road located between two or more road intersections. In some embodiments, a road network comprises one or more road sections.

In some embodiments, each of the GPS nodes (e.g., latitude (L) and longitude (G)) received by operations center 300 are divided into two or more groups. In some embodiments, the two or more groups comprise GPS points and associated GPS points.

In some embodiments, the GPS points correspond to GPS nodes not associated with one or more road sections. In some embodiments, GPS nodes not associated with one or more road sections correspond to GPS nodes that do not contact one or more road sections. In some embodiments, the GPS points were not accurately determined by the GPS unit (22). In some embodiments, the map match system 502 utilizes the GPS points to correct the GPS points determined by the GPS unit (22). In some embodiments, the map match system 502 utilizes the GPS points to correct the estimated path determined by the operations center 500.

In some embodiments, the associated GPS points correspond to GPS nodes associated with one or more road sections. In some embodiments, GPS nodes associated with one or more road sections correspond to GPS nodes that contact one or more road sections. In some embodiments, the associated GPS points were accurately determined by the GPS unit (22).

In operation 604, a range search is performed for each GPS point of the one or more GPS points. In some embodiments, a range search determines one or more road sections within a range of each GPS point. In some embodiments, the range is a radius from each GPS point. The range search performed by operation 604 comprises operations 604a, operation 604b and operation 604c.

In operation 604a, a circle of radius r is created around each of the GPS points. In some embodiments, each of the GPS points is the center of the circle.

In operation 604b, the method of determining a vehicle path determines if the circle partially encloses one or more road sections. If the method of determining a vehicle path determines the circle partially encloses one or more road sections, the operation proceeds to operation 606. If the method of determining a vehicle path determines the circle does not at least partially enclose one or more road sections, the operation proceeds to operation 604c.

In operation 604c, each of the GPS points is discarded. In some embodiments, each of the GPS points is discarded since the GPS point is not associated with one or more road sections. In some embodiments, the discarded GPS point is an erroroneous data point. Afterwards, the operation proceeds to operation 610.

In operation 606, one or more unique GPS snap points is determined for each of the one or more GPS points. In some embodiments, each of the one or more unique GPS snap points is a translation of the corresponding member of the one or more GPS points to one or more road sections. In some embodiments, each of the one or more GPS points is associated with a corresponding member of the one or more unique GPS snap points.

In operation 608, one or more estimated vehicle paths are determined for each of the one or more unique GPS snap points. In some embodiments, each of the one or more estimated vehicle paths is an estimated path for the vehicle based upon each of the one or more unique GPS snap point.

In operation 610, method of determining a vehicle path determines if there are any more GPS points. If the method of determining a vehicle path determines one or more GPS points are not available, the operation proceeds to operation 612. If the system for method of determining a vehicle path determines one or more GPS points are available, the operation proceeds to operation 602.

In operation 612, the vehicle path is determined from the one or more estimated vehicle paths. In some embodiments, the vehicle path is determined by selecting the vehicle path from the one or more estimated vehicle paths according to a first relevant information. In some embodiments, the first relevant information comprises a minimum value.

In some embodiments, each estimated vehicle path of the one or more estimated vehicle paths is associated with a corresponding member of one or more costs. In some embodiments, the minimum value is a minimum value of the corresponding member of the one or more costs. In some embodiments, each corresponding member of the one or more costs for each estimated vehicle path of the one or more estimated vehicle paths comprises a sum of one or more distances. In some embodiments, each distance of the one or more distances is a distance between each of the GPS points of the one or more GPS points and each of the corresponding unique GPS snap points of the one or more unique GPS snap points contained in each of the one or more estimated vehicle paths.

In some embodiments, the corresponding member of the one or more costs for each estimated vehicle path of the one or more estimated vehicle paths is a calculated error for each of the one or more estimated paths. In some embodiments, the calculated error is minimized by selecting the one or more paths associated with the minimum calculated error.

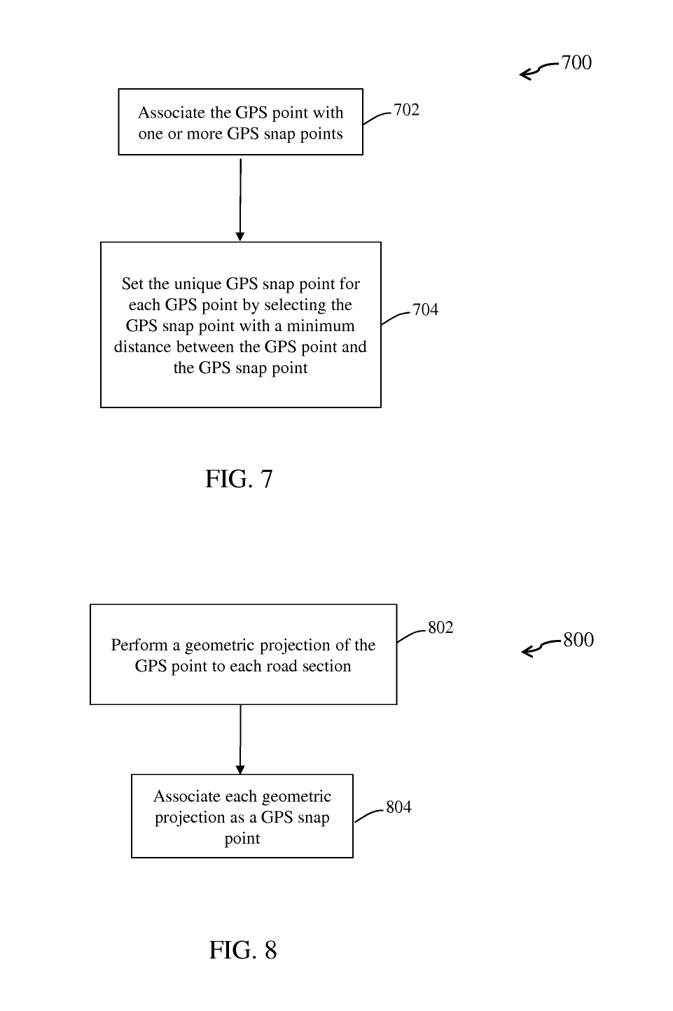

FIG. 7 is a flow chart of a method 700 of determining each of the one or more unique GPS snap points for each GPS point of the one or more GPS points in accordance with one or more embodiments. Method 700 is an embodiment of operation 606 shown in FIG. 6. Method 700 begins with operation 702, each of the one or more GPS points are associated with one or more GPS snap points. In some embodiments, each GPS snap point of the one or more GPS snap points is a translation of the GPS point of the one or more GPS points.

In operation 704, each of the one or more unique GPS snap points are set. In some embodiments, each of the one or more unique GPS snap points are set by selecting the GPS snap point of the one or more GPS snap points according to a second relevant information. In some embodiments, the second relevant information comprises a minimum distance between each GPS point of the one or more GPS points and each GPS snap point of the one or more GPS snap points.

FIG. 8 is a flow chart of a method 800 of associating each of the one or more GPS points with one or more GPS snap points in accordance with one or more embodiments. Method 800 is an embodiment of operation 702 shown in FIG. 7. Method 800 begins with operation 802, a geometric projection of each GPS point of the one or more GPS points is performed to each of the one or more road sections.

In operation 804, each geometric projection of each GPS point of the one or more GPS points is associated with each GPS snap point of the one or more GPS snap points.

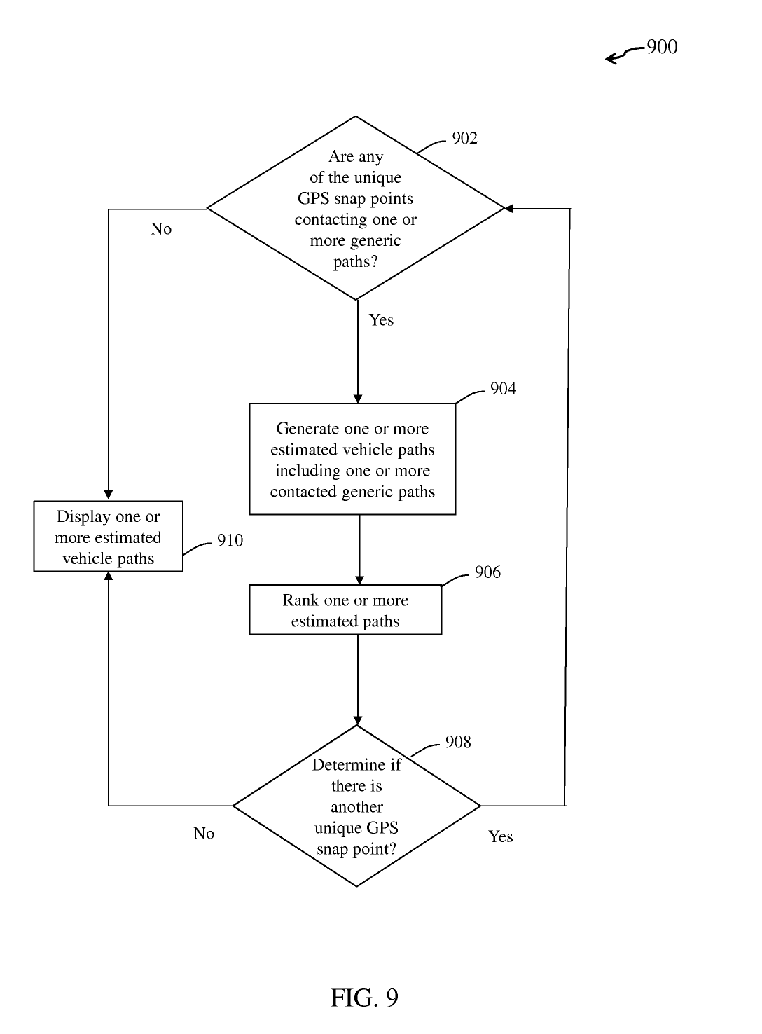

FIG. 9 is a flow chart of a method 900 of determining one or more estimated vehicle paths for each of the one or more unique GPS snap points in accordance with one or more embodiments. Method 900 is an embodiment of operation 608 shown in FIG. 6. Method 900 begins with operation 902, the method of determining one or more estimated vehicle paths for each of the one or more unique GPS snap points determines whether each of the one or more unique GPS snap points contacts one or more generic paths. If the method of determining a vehicle path determines each of the one or more unique GPS snap points contacts one or more generic paths, the operation proceeds to operation 904. If the method of determining a vehicle path determines each of the one or more unique GPS snap points does not contact one or more generic paths, the operation proceeds to operation 910. In some embodiments, each of the one or more generic paths comprises one or more previously estimated vehicle paths. In some embodiments, one or more previously estimated vehicle paths is a previous estimated vehicle path associated with a different set of one or more GPS points or a different set of one or more unique GPS snap points.

In operation 904, one or more estimated vehicle paths are generated. In some embodiments, one or more estimated vehicle paths comprise one or more generic paths. In some embodiments, each of the one or more estimated vehicle paths is associated with a corresponding member of one or more costs.

In some embodiments, the corresponding member of the one or more costs for each estimated vehicle path of the one or more estimated vehicle paths comprises a sum of one or more distances. In some embodiments, each distance of the one or more distances is a distance between each of the GPS points of the one or more GPS points and each of the corresponding unique GPS snap points of the one or more unique GPS snap points contained in each of the one or more estimated vehicle paths. In some embodiments, the corresponding member of the one or more costs for each estimated vehicle path of the one or more estimated vehicle paths is a calculated error for each of the one or more estimated paths.

In operation 906, one or more estimated vehicle paths are ranked according to a third relevant information. In some embodiments, the third relevant information comprises the corresponding member of the one or more costs associated with each estimated vehicle path of the one or more estimated vehicle paths. In some embodiments, the calculated error is minimized by ranking the one or more estimated vehicle paths according to the calculated error, and selecting the one or more paths associated with the minimum calculated error (e.g., operation 612 of FIG. 6).

In operation 908, the method of determining one or more estimated vehicle paths for each of the one or more unique GPS snap points determines whether there are more unique GPS snap points. If the method of determining one or more estimated vehicle paths for each of the one or more unique GPS snap points determines there are more unique GPS snap points, the operation proceeds to operation 902. If the method of determining one or more estimated vehicle paths for each of the one or more unique GPS snap points determines there are no more unique GPS snap points, the operation proceeds to operation 910.

In operation 910, one or more estimated vehicle paths are displayed. In some embodiments, the map match system 502 displays the one or more estimated vehicle paths at the operations center 300.

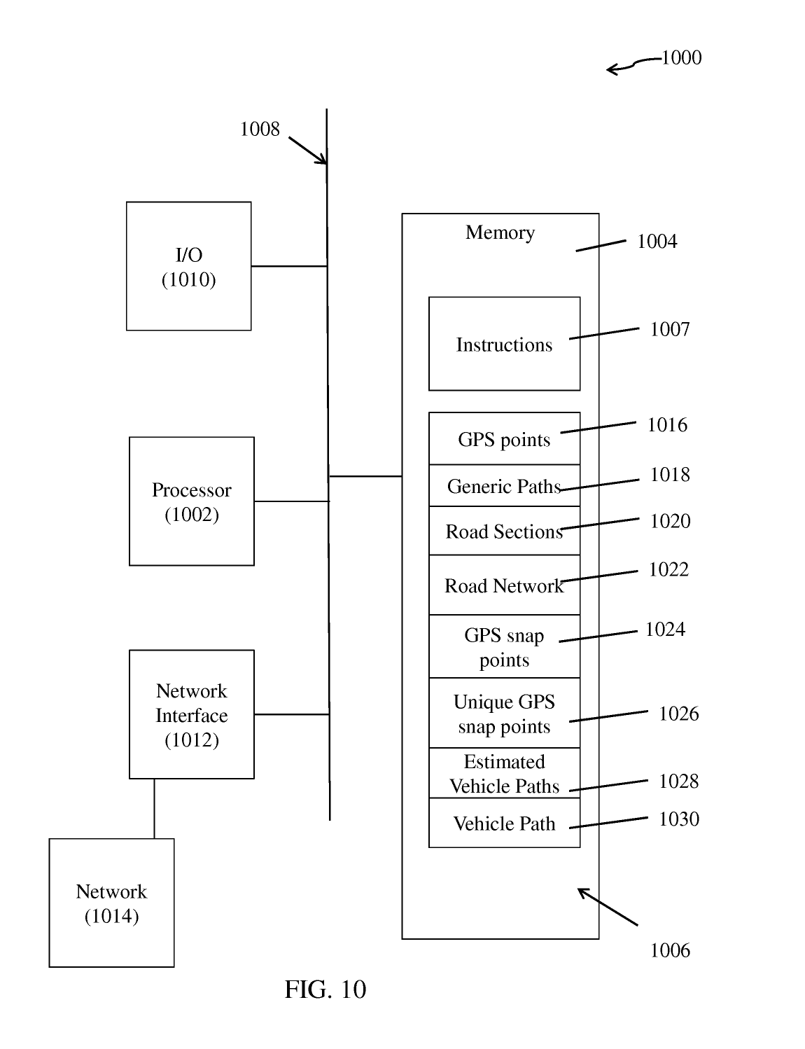

FIG. 10 is a block diagram of a map match system 1000 for determining a vehicle path in accordance with one or more embodiments. In some embodiments, the map match system 1000 is an embodiment of the map match system 502 shown in FIG. 5. In some embodiments, the map match system 1000 is a general purpose computing device which implements method 600 of FIG. 6, method 700 of FIG. 7, method 800 of FIG. 8 or method 900 of FIG. 900 in accordance with one or more embodiments. Map match system 1000 includes a hardware processor 1002 and a non-transitory, computer readable storage medium 1004 encoded with, i.e., storing, the computer program code 1006, i.e., a set of executable instructions. Computer readable storage medium 1004 is also encoded with instructions 1007 for interfacing with the operations center 500. The processor 1002 is electrically coupled to the computer readable storage medium 1004 via a bus 1008. The processor 1002 is also electrically coupled to an I/O interface 1010 by bus 1008. A network interface 1012 is also electrically connected to the processor 1002 via bus 1008. Network interface 1012 is connected to a network 1014, so that processor 1002 and computer readable storage medium 1004 are capable of connecting to external elements via network 1014. The processor 1002 is configured to execute the computer program code 1006 encoded in the computer readable storage medium 1004 in order to map match system 1000 to be usable for performing a portion or all of the operations as described e.g., in method 600, method 700, method 800 or method 900.

In one or more embodiments, the processor 1002 is a central processing unit (CPU), a multi-processor, a distributed processing system, an application specific integrated circuit (ASIC), and/or a suitable processing unit.

In one or more embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random access memory (RAM), a read-only memory (ROM), a rigid magnetic disk, and/or an optical disk. In one or more embodiments using optical disks, the computer readable storage medium 1004 includes a compact disk-read only memory (CD-ROM), a compact disk-read/write (CD-R/W), and/or a digital video disc (DVD).

In one or more embodiments, the storage medium 1004 stores the computer program code 1006 configured to cause map match system 1000 to perform method 600, method 700, method 800 or method 900. In one or more embodiments, the storage medium 1004 also stores information needed for performing method 600, method 700, method 800 or method 900 as well as information generated during performing method 600, method 700, method 800 or method 900, such as GPS points 1016, generic paths 1018, road sections 1020, road network 1022, GPS snap points 1024, unique GPS snap points 1026, estimated vehicle paths 1028 and vehicle path 1030, and/or a set of executable instructions to perform the operation of method 600, method 700, method 800 or method 900.

In one or more embodiments, the storage medium 1004 stores instructions 1007 for interfacing with external machines. The instructions 1007 enable processor 1002 to generate instructions readable by the external machines to effectively implement method 600, method 700, method 800 or method 900 during a vehicle path determination process.

Map match system 1000 includes I/O interface 1010. I/O interface 1010 is coupled to external circuitry. In one or more embodiments, I/O interface 1010 includes a keyboard, keypad, mouse, trackball, trackpad, touchscreen, and/or cursor direction keys for communicating information and commands to processor 1002.

Map match system 1000 also includes network interface 1012 coupled to the processor 1002. Network interface 1012 allows system 1000 to communicate with network 1014, to which one or more other computer systems are connected. Network interface 1012 includes wireless network interfaces such as BLUETOOTH, WIFI, WIMAX, GPRS, or WCDMA; or wired network interfaces such as ETHERNET, USB, or IEEE-1394. In one or more embodiments, method 600, method 700, method 800 or method 900 are implemented in two or more systems 1000, and information such as GPS points 1016, generic paths 1018, road sections 1020, road network 1022, GPS snap points 1024, unique GPS snap points 1026, estimated vehicle paths 1028 and vehicle path 1030 are exchanged between different systems 1000 via network 1014.

System 1000 is configured to receive information related to one or more GPS points 1016 through I/O interface 1010. The information is transferred to processor 1002 via bus 1008 to generate one or more GPS points 1016. The one or more GPS points 1016 are then stored in computer readable medium 1004 as GPS points 1016. System 1000 is configured to receive information related to one or more generic paths 1018 through I/O interface 1010. The information is transferred to processor 1002 via bus 1008 to generate one or more generic paths 1018. The one or more generic paths 1018 are then stored in computer readable medium 1004 as generic paths 1018. Map match system 1000 is configured to receive information related to one or more road sections 1020 through I/O interface 1010. The information is stored in computer readable medium 1004 as road sections 1020. Map match system 1000 is configured to receive information related to one or more road networks through I/O interface 1010. The information is stored in computer readable medium 1004 as road network 1022. Map match system 1000 is configured to receive information related to one or more GPS snap points through I/O interface 1010. The information is stored in computer readable medium 1004 as GPS snap point 1024. Map match system 1000 is configured to receive information related to one or more unique GPS snap points through I/O interface 1010. The information is stored in computer readable medium 1004 as unique GPS snap points 1026. Map match system 1000 is configured to receive information related to one or more estimated vehicle paths through I/O interface 1010. The information is stored in computer readable medium 1004 as estimated vehicle paths 1028. Map match system 1000 is configured to receive information related to a vehicle path through I/O interface 1010. The information is stored in computer readable medium 1004 as vehicle path 1030.

One of ordinary skill in the art would recognize that an order of operations in method 600, method 700, method 800 or method 900 is adjustable. One of ordinary skill in the art would further recognize that additional steps are able to be included in method 600, method 700, method 800 or method 900 without departing from the scope of this description.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

One aspect of this description relates to a method of characterizing the driving style of a vehicle driver comprising determining, by a processor, a vehicle path of a driver, determining one or more average speed values of the vehicle driver from at least the vehicle path, determining a number of times an average vehicle speed in one or more directions is exceeded by the one or more average speed values of the vehicle driver and characterizing the driving style of the vehicle driver from at least the one or more average speed values of the vehicle driver. Determining a vehicle path of a driver comprises loading one or more GPS points or one or more generic paths, performing a range search for each GPS point of the one or more GPS points, determining one or more unique GPS snap points for each GPS point of the one or more GPS points, determining one or more estimated vehicle paths for each unique GPS snap point of the one or more unique GPS snap points and determining a vehicle path from the one or more estimated vehicle paths, wherein the vehicle path is a path of the vehicle driver. Further, each unique GPS snap point of the one or more unique GPS snap points is a translation of the corresponding GPS point of the one or more GPS points. The range search determines one or more road sections within a range of each GPS point of the one or more GPS points. Also, each generic path of the one or more generic paths is a connection of one or more generic road sections of a road network.

What is claimed is:

1. A method of characterizing the driving style (P) of a vehicle driver, comprising the following steps:
determining, by a processor, a vehicle path of a driver comprising:
loading one or more GPS points or one or more generic paths, wherein each generic path of the one or more generic paths is a connection of one or more generic road sections of a road network;
performing a range search for each GPS point of the one or more GPS points, wherein the range search determines one or more road sections within a range of each GPS point of the one or more GPS points;
determining one or more unique GPS snap points for each GPS point of the one or more GPS points, wherein each unique GPS snap point of the one or more unique GPS snap points is a translation of the corresponding GPS point of the one or more GPS points;
determining one or more estimated vehicle paths for each unique GPS snap point of the one or more unique GPS snap points;
determining a vehicle path from the one or more estimated vehicle paths, wherein the vehicle path is a path of the vehicle driver;
determining one or more average speed values of the vehicle driver from at least the vehicle path;
determining a number of times an average vehicle speed in one or more road sections is exceeded by the one or more average speed values of the vehicle driver; and
characterizing the driving style of the vehicle driver from at least the one or more average speed values of the vehicle driver.

2. The method of claim 1, wherein determining a vehicle path from the one or more estimated vehicle paths comprises:
selecting the vehicle path from the one or more estimated vehicle paths according to a first relevant information.

3. The method of claim 1, wherein the first relevant information comprises a minimum value;
wherein each estimated vehicle path of the one or more estimated vehicle paths is associated with a corresponding member of one or more costs;
wherein each corresponding member of the one or more costs for each estimated vehicle path of the one or more estimated vehicle paths comprises a sum of one or more distances, wherein each distance of the one or more distances is between each of the GPS points of the one or more GPS points and each of the corresponding unique GPS snap points of the one or more unique GPS snap points contained in each of the one or more estimated vehicle paths; and
wherein the minimum value is a minimum value of the corresponding member of the one or more costs.

4. The method of claim 1, wherein the range search for each GPS point of the one or more GPS points comprises:
creating a circle of a radius;
determining whether the circle partially encloses one or more road sections; and
discarding each GPS point of the one or more GPS points, if the circle does not at least partially enclose the one or more road sections.

5. The method of claim 1, wherein determining each unique GPS snap point of the one or more unique GPS snap points for each GPS point of the one or more GPS points comprises:
associating each GPS point of the one or more GPS points with one or more GPS snap points, wherein each GPS snap point of the one or more GPS snap points is a translation of the GPS point of the one or more GPS points; and
setting each unique GPS snap point of the one or more unique GPS snap points comprises selecting the GPS snap point of the one or more GPS snap points according to a second relevant information.

6. The method of claim 5, wherein associating each GPS point of the one or more GPS points with one or more GPS snap points comprises:
performing a geometric projection of each GPS point of the one or more GPS points to each of the one or more road sections; and
associating each geometric projection of each GPS point of the one or more GPS points with each GPS snap point of the one or more GPS snap points.

7. The method of claim 5, wherein the second relevant information comprises a minimum distance between each GPS point of the one or more GPS points and each GPS snap point of the one or more GPS snap points.

8. The method of claim 1, wherein determining one or more estimated vehicle paths for each of the one or more unique GPS snap points comprises:
determining whether each of the one or more unique GPS snap points contacts one or more generic paths;
generating one or more estimated vehicle paths comprising one or more generic paths, if each of the one or more unique GPS snap point contacts one or more generic paths; and
ranking the one or more estimated vehicle paths according to a third relevant information, if each of the one or more unique GPS snap point contacts one or more generic path; and
wherein each estimated vehicle path of the one or more estimated vehicle paths is associated with a corresponding member of one or more costs.

9. The method of claim 8, wherein the third relevant information is the corresponding member of one or more costs.

10. The method of claim 8, wherein each corresponding member of the one or more costs for each estimated vehicle path of the one or more estimated vehicle paths comprises a sum of one or more distances, wherein each distance of the one or more distances is between each of the GPS points of the one or more GPS points and each of the corresponding unique GPS snap points of the one or more unique GPS snap points contained in each of the one or more estimated vehicle paths.

11. The method of claim 1, wherein each of the GPS points of the one or more GPS points is not associated with one or more road sections.

12. The method of claim 1, wherein each of the GPS points of the one or more GPS points does not contact one or more road sections.

13. The method of claim 1, wherein the one or more generic paths comprise one or more previously estimated vehicle paths.

14. A method according to claim 1, further comprising:
a) detection of acceleration (X, vᵥ) of the vehicle by means of an accelerometer (21),
b) comparison of said acceleration (X, vᵥ) with preset threshold values (S1, S2, S3) to detect sudden accelerations/decelerations (A, D) indicative of improper driving and very sudden accelerations/decelerations (I) indicative of an accident,
c) detection of latitude (L), longitude (G) and speed (V) values of the vehicle by means of a GPS module (22),
d) storage of said sudden accelerations/decelerations (A, D) and very sudden accelerations/decelerations (I) and said latitude (L), longitude (G) and speed (V) values of the vehicle in a memory (34),
e) transmission of said values (A, D, I, L, G, V) stored in the memory to a remote operations center (300) by means of a GSM/GPRS module (24), in such manner to calculate information on the number of sudden accelerations/decelerations (Tii) and number of accidents (Tiv),
f) projection of the latitude (L) and longitude (G) values detected by the GPS (22) on digital mapping in such manner that, by following the route of the vehicle on the map, information is obtained about:
total Kilometers traveled by the vehicle (Ti);
Kilometers traveled by the vehicle on different types of road (Tiv, Tv, Tvi, Tix, Tx);
transits of the vehicle through a junction or around a roundabout (Tvii, Tviii);
g) determining a number of times the average vehicle speed in one or more road sections is exceeded by one or more speed values detected by the GPS unit;
h) matching of speed values (V) detected by the GPS (22) with the roads traveled by the vehicle detected from the mapping, in order to obtain information (Txi, Txii, Txiii) on the average speed on various types of roads,
characterizing the driving style of the vehicle driver from at least the one or more speed values detected by the GPS module;
generating a polynomial (P) with the values of the information obtained in steps (e, f, g, h) that represents the characterization of the driving style of the vehicle driver,
wherein if the GPS signal is not available for the GPS module (22), the speed of the vehicle (V) is detected by an information retrieval device (103) connected to the control unit of the vehicle and sent to the memory (34) of the device by means of Bluetooth modules (102, 9).

15. A method according to claim 14, wherein said threshold values (2) comprise:
a first threshold value (S1) indicative of a sudden acceleration;
a second threshold value (S2) indicative of a sudden deceleration; and
a third threshold value (S3) indicative of a very sudden acceleration/deceleration that occurs with an accident.

16. A method according to claim 15, wherein said accelerometer (21) detects an acceleration vector vₐ(x,y,z) in its reference system along three axes that is converted, by means of rotation, into an accelerator vector vᵥ(x,y,z) in the reference system of the vehicle, wherein the component (X) of the vector (vᵥ), corresponds the measure of the instantaneous acceleration in the traveling direction of the vehicle and is compared with the first threshold value (S1) and the second threshold value (S2) to detect respectively sudden accelerations (A) and decelerations (D) and wherein the module of vector (vᵥ) is compared with said third threshold value (S3) to detect very sudden accelerations/decelerations (I) indicative of an accident.

17. A method according to claim 16, wherein the module of vector (vᵥ) exceeds the third threshold value (S3), all accelerations/decelerations (A, D) sampled in a time interval comprising the instant when the third threshold value (S3) is exceeded are recorded in the memory (34).

18. A method according to claim 17, wherein said sampling interval of accelerations/decelerations (A, D) is comprised between 10 seconds before and 3 seconds after the instant when the third threshold value (S3) is exceeded.

19. A method according to claim 15, wherein said first threshold value (S1) is equal to ½ g, said second threshold value (S2) is equal to −½ g and said third threshold value (S3) is equal to 2 g.

20. A method according to claim 14, wherein the accelerometer (21) is sampled with a frequency comprised between 800-1200 Hz and said GPS module (22) is sampled with frequency comprised between 1 and 10 Hz.
